(19) United States
(12) Patent Application Publication
(10) Pub. No.: US 2009/0289833 A1
(43) Pub. Date: Nov. 26, 2009

(54) Sparse array millimeter wave imaging system

(76) Inventors: Paul A. Johnson, El Cajon, CA (US); Vladimir Kolinko, San Diego, CA (US)

Correspondence Address: TREX ENTERPRISES CORP., 10455 PACIFIC COURT, SAN DIEGO, CA, 92121, US

(21) Appl. No.: 12/154,450

(22) Filed: May 23, 2008

(51) Int. Cl. G01S 13/00

(52) U.S. Cl. 342/118; 342/179

(57) ABSTRACT

An active millimeter-wave imaging system that can provide a means of surmounting the deficiencies of earlier millimeter-wave systems, as well as lowering the system cost substantially. Earlier systems have employed large numbers of individual millimeter-wave receivers in either focal plane arrays or frequency scanned antenna arrays, and these systems have suffered from low frame rate, poor contrast, and relatively low resolution. By employing a sparse array of millimeter-wave transmitters and receivers, covering a relatively large, flat, physical aperture, a low cost and high resolution system can be achieved. By employing active millimeter-wave illumination, contrast and frame rate issues can be mitigated, at long ranges (10's of meters). A new approach, termed Fourier Telescopy, allows the illuminating signals to interrogate the various spatial frequencies of the target, and the image to be reconstructed from these various spatial frequency components.

### FIELD OF INVENTION

This invention relates to imaging systems and in particular to millimeter-wave and radio frequency (RF) imaging systems.

### BACKGROUND OF THE INVENTION

### Prior Art Millimeter Wave Imaging Systems

Portal security and detection of concealed weapons and explosives at a distance are some of the most pressing problems facing both homeland and deployed personnel. For several years, the Applicants employer and several other organizations have been addressing this problem by developing passive millimeter-wave imaging systems. These systems have been shown able to detect concealed weapons and explosive devices hidden underneath clothing. Though effective, these systems have suffered from low frame rates, poor spatial resolution, and low contrast. FIG. 1 illustrates a comparison of Visible 20 and Passive Millimeter-Wave 21 images of subjects carrying concealed objects, but what is needed is a high contrast, video rate millimeter-wave imaging system that can provide high resolution of objects hidden under clothing from a distance of more than a few meters.

### Principle of Fourier Telescopy Active Imaging

The theoretical resolution of a passive imaging system is limited by diffraction to be λAR/D, where λ is the imaging wavelength, R is the range to the object, and D is the effective size of the aperture/lens optical system. The value of D must be large enough to yield the required resolution for a given imaging mission, and also enough measured signal to overcome the effects of detector and background noise. In the past, lasers have been used to illuminate objects in a manner described below. In particular an Active Imaging technique known as Fourier Telescopy also allows one to overcome the traditional limits on resolution by practical constraints on the size of the optical aperture. Fourier Telescopy has for example been proposed for imaging very distant objects such as orbiting satellites.

What is needed is a better millimeter wave imaging system especially for security and concealed weapons detection.

### SUMMARY OF THE INVENTION

The present invention provides an active millimeter-wave imaging system that can provide a means of surmounting the deficiencies of earlier millimeter-wave systems, as well as lowering the system cost substantially. Earlier systems have employed large numbers of individual millimeter-wave systems receivers in either focal plane arrays or frequency scanned antenna arrays, and these systems have suffered from low frame rate, poor contrast, and relatively low resolution. By employing a sparse array of millimeter-wave transmitters and receivers, covering a relatively large, flat, physical aperture, a low cost and high resolution system can be achieved. By employing active millimeter-wave systems illumination, contrast and frame rate issues can be mitigated, at long ranges (10's of meters). A new approach, termed Fourier Telescopy, allows the illuminating signals to interrogate the various spatial frequencies of the target, and the image to be reconstructed from these various spatial frequency components.

### BRIEF DESCRIPTION OF THE DRAWINGS

FIG. 1 shows prior art millimeter wave images compared to visible light images.

FIG. 2 shows simulated satellite images.

FIG. 3 shows millimeter wave beams interfering to produce fringes sweeping across a target.

FIG. 4 shows a preferred transmitter array pattern.

FIG. 5 illustrates how a image is constructed from frequency data.

FIGS. 6 and 6A and 6B show preferred techniques for generating millimeter-wave beams.

FIG. 7 shows additional details regarding the formation of images.

FIG. 8 shows a variety of transmitter array patterns.

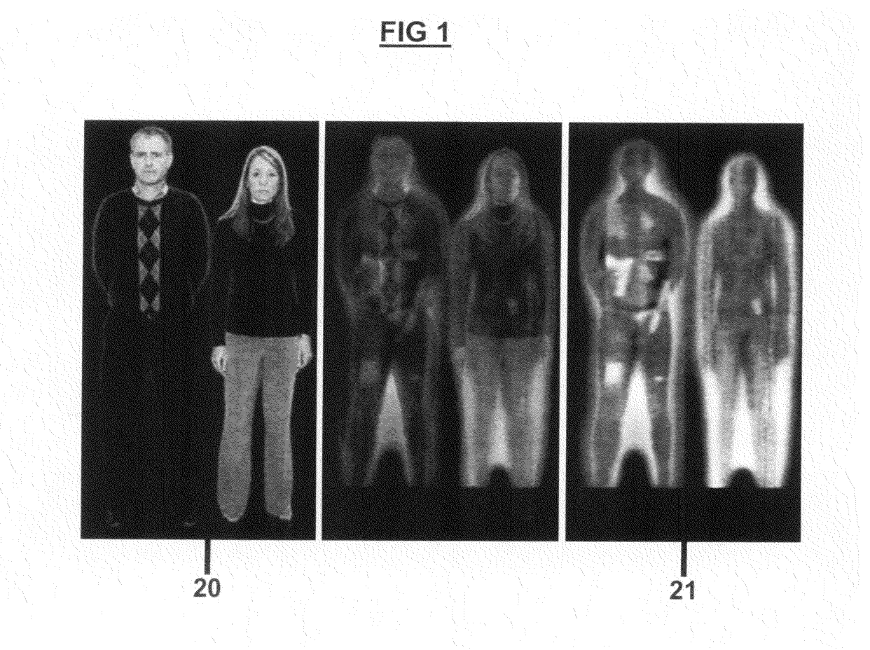

### DETAILED DESCRIPTION OF PREFERRED EMBODIMENTS

### Sparse Array Imaging

The key technical question is how to obtain resolution on the order of 5 cm in a practical system using state-of-art components, for reasonable cost and use in a variety of surveillance field applications. First, we will provide active illumination using mm-wave transmitters, so that the image quality is of sufficiently high signal-to-noise (SNR). Second, we will employ a Fourier Telescopy (FT) method, as adapted from the prior experience of the Applicants and their associates in active imaging using lasers, to synthesize an image with resolution equivalent to using a passive 3-m lens, from a sparse array of transmitters and receivers.

The FT method works as follows. An N×N 2-dimensional image I(x,y) is completely characterized by its Fourier spectrum F(u,v), where the u,v are the x- and y-coordinate wave-vectors of the object in spatial frequency space:

I(x,y)=∫[F(u,v)·e^{i2π(ux+vy)}]dudv

Vectors (u,v) with large magnitude correspond to low spatial frequencies, or large scale spatial features of the object (i.e., shape, size, form). Small magnitudes correspond to high-spatial frequencies, or small-scale features which provide high-resolution details. The FT method provides active direct measurement of the array F(u,v) of Fourier components, in real time, and at high SNR, due to the fact that strength of the received signal can be made sufficiently large by providing enough power in the illuminating transmitters.

To measure F(u,v), a 2-dimensional spatial array of small transmitters is used to project mm-wave power on the target. Each transmitter m is located at position (xₘ,yₘ) within the array. In order to “tag” its transmission signal to distinguish it from the other transmitters, it is given an offset or modulation frequency wm: Iₘ(t)=Iₘ0·e^{(iω}^{ₘ}^{t)}, where Iₘ0 is the DC intensity of the m^{th} transmitter. Transmitter n at (xₙ,yₙ) is similarly tagged with frequency offset ωₙ. The resulting intensity pattern on the target is a spatially- and time-varying pattern of interference, or fringes.

The fundamental measurement of FT is then simply the received intensity reflected off the target I_{rec}(t), as a function of time, as detected using a separate receiver or array of receivers within the field of view of the target.

In order to extract the desired spatial Fourier components, the measured intensity I(t) is then Fourier transformed in the time-frequency domain, which results in a is the DC intensity of 1-dimensional distribution of amplitudes as a function of the beat-frequencies ωₘₙ=ωₘ−ωₙ. The amplitudes extracted from the Fourier transform of the measured intensity can be shown simply to differences of Fourier components be the desired spatial Fourier components D(m,n)=F(uₘ,vₘ)−F(uₙ,vₙ), in the 2-dimensional u,v plane. From the finite difference array D(m,n), the 2-dimensional function F(u,v) can be reconstructed, using extensions of finite-grid least-squares methods. Note that the quantity dₘₙ is the distance between transmitters m and n. This distance is referred to as an FT “baseline”. Measurements corresponding to small transmitter baselines yield low-frequency information on the power spectrum of the object; large baselines yield high frequency, and hence high-resolution, information.

The FT method thus uses basic principles of Fourier transformation in both spatial and time-domains to directly measure the Fourier components necessary to reconstruct an image. The process of active illumination can be carried out over any time interval over which the target remains static in the field of view of the receivers. Today's mm-wave components and basic microprocessor technology allow the entire process to be carried out in a very small fraction of a second.

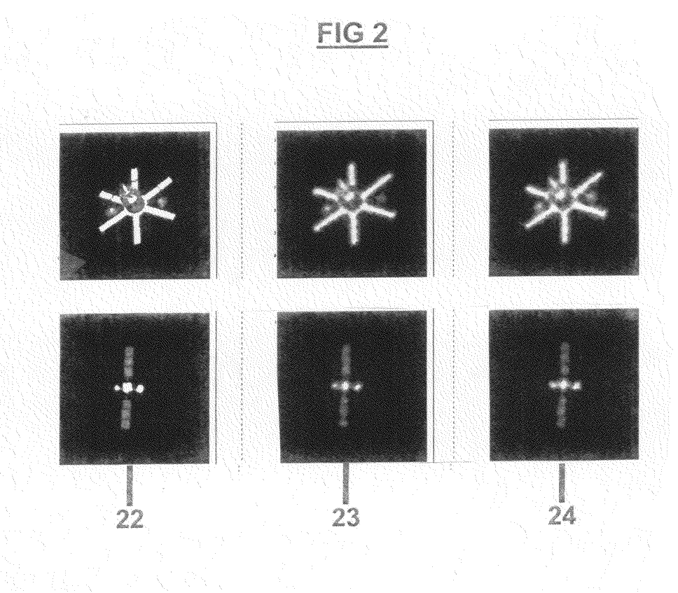

The advantages of the FT method are many. First, it can be seen that the highest-frequency components of the FT reconstructed image correspond to largest baselines dₘₙ, and in fact the compared to conventional passive imaging the equivalent resolution is D=(dₘₙ)max. Thus, even a relatively sparse array of transmitters with large spacing can yield the same resolution as a very large single lens, at much lower cost and weight. FIG. 2 shows an example of active illumination FT imaging as applied by the inventor's associates in the optical spectrum, using laser-based illumination. Referring to FIG. 2, shown at 22 is a 3.5 mm test target, at 23 is the FT limit of the best reconstructed image, and at 24 is the actual FT reconstructed image of the target when illuminated at a range of 1500 meters.

Secondly, measurement of the intensity obtained by direct illumination by a single laser gives a complex non-uniform pattern of speckles, of size l·R/s, where s is the size of the object. For s=2 m (typical human), l=3 mm, and R=50 m, we obtain a speckle size of roughly 10 cm. Thus, a direct image from non-FT mm-wave illumination would be very granular, and many examples would be required while the object is stationary to achieve a smooth, high-resolution image. By using an FT receiver array of much larger dimension than the speckle size, the rapidly varying speckle pattern is averaged out in the direct FT intensity I(t). This means that FT is essentially an “incoherent” imaging method, whereby a single FT image reconstruction is uniform and has high SNR compared to a single speckle image.

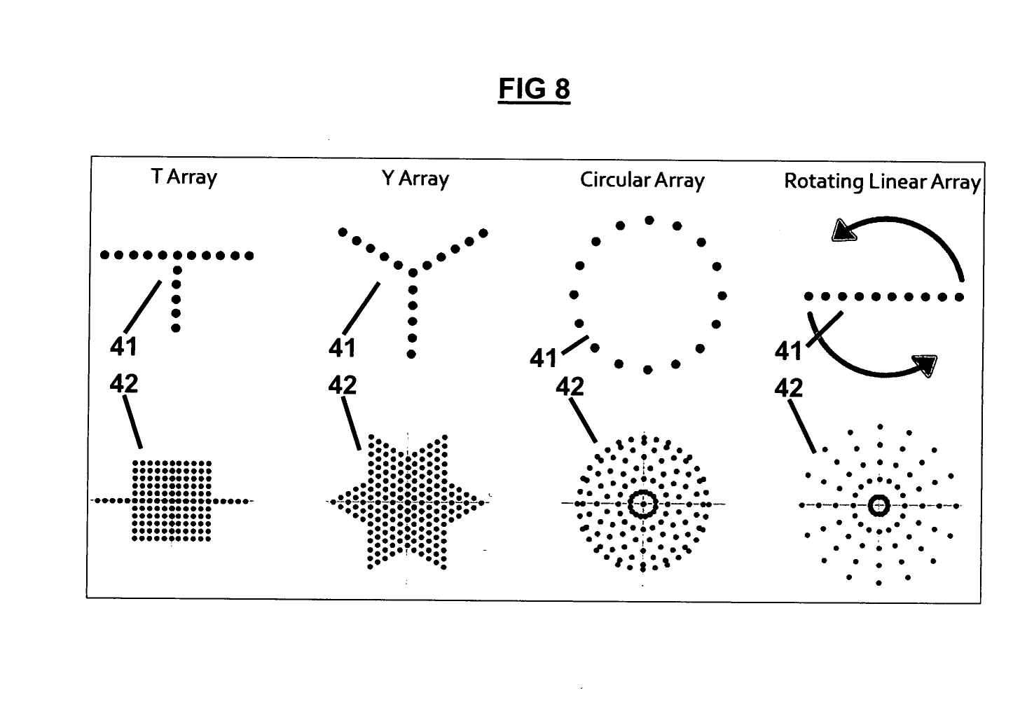

Several different configurations of sparse array may be used to recover the Fourier components of the image, some examples of which are shown in FIG. 8. Ideally, the Fourier space will be completely filled in, resulting in a good representation of the image, but in practicality, the sparse array shape determines which Fourier components of the image are measured. FIG. 8 illustrates the transmitter/receiver configurations and their respective Fourier components that can be recovered from the pair-wise combination of all of the elements in the sparse array. For example, if the sparse array of transmitters/receivers has ‘T’ shape 41, then the Fourier components of the image that can be measure are shown by 42. If the transmitters/receivers have ‘Y’ shape 43, then the Fourier components that are measured are illustrated by 43. Similarly, Fourier components 46 and 48 are measured by sparse array shapes illustrated by 45 and 47.

Measurements acquired by the sparse array can be done in several different ways. In the simplest approach, a single receiver is used and the transmitters are activated one pair at a time, creating an interference pattern on the target. By adding a frequency offset between the two transmitters, the interference pattern sweeps across the target at a rate equal to the frequency difference. In a slightly more complicated system, a single receiver is used, but all the transmitters are activated simultaneously, each with a specific frequency offset, such that each pair of transmitters has a specific difference in frequency—no two pairs of transmitters have the same frequency offset. This creates interference patterns in multiple directions and sizes on the target simultaneously, which are sorted out in the receiver by looking at the frequency differences one at a time. In a more complicated system, some trade-off is made between transmitters and receivers, with the interference pattern that is observed becoming a function of both transmitter and receiver spacings.

### First Preferred Embodiment

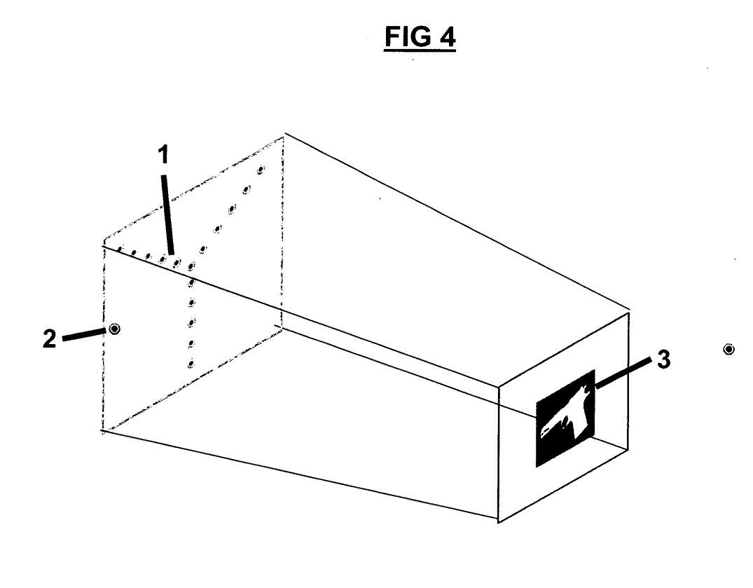

A preferred embodiment of a millimeter-wave (mmw) Fourier Telescopy (FT) system will have a ‘Y’ shaped arrangement of sixteen Transmitting Sources 1, and a single Receiver 2, as shown in FIG. 4. This arrangement of transmitters will allow for sufficient sampling of the spatial frequencies of the target Object Plane 3 to allow an inverse Fourier transform to be used to recover the image.

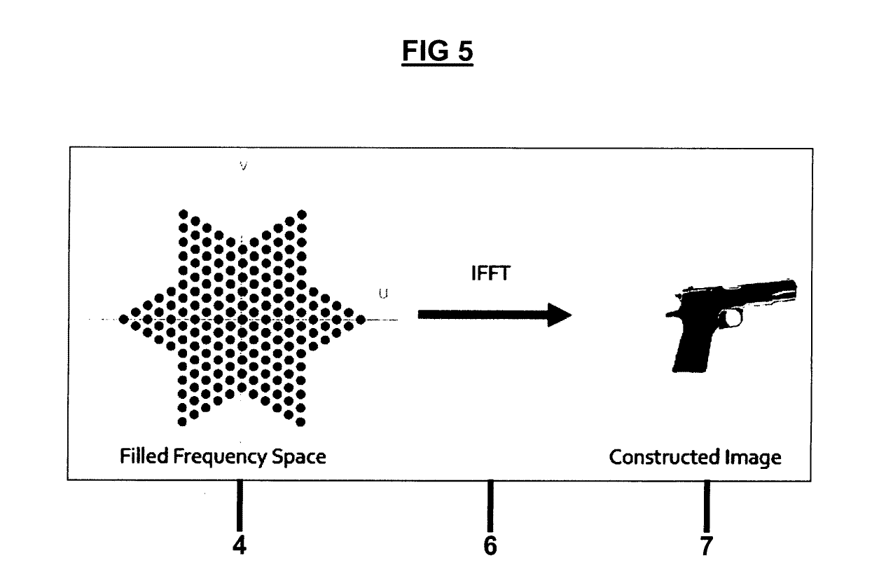

The ‘Y’-shaped arrangement of transmitting sources 1 when operated in pairs across all possible combinations of two sources, creates an interference pattern for each pair of transmitters at the object plane that samples the spatial frequencies of the target image as shown as the Filled Frequency Space 4, in FIG. 5. Once the spatial frequency space 4 is filled by operating all possible pairs of transmitters, then Inverse Fourier Transform (IFFT) 6 is performed (using techniques standard in the industry) to derive the Constructed Image 7, shown in FIG. 5.

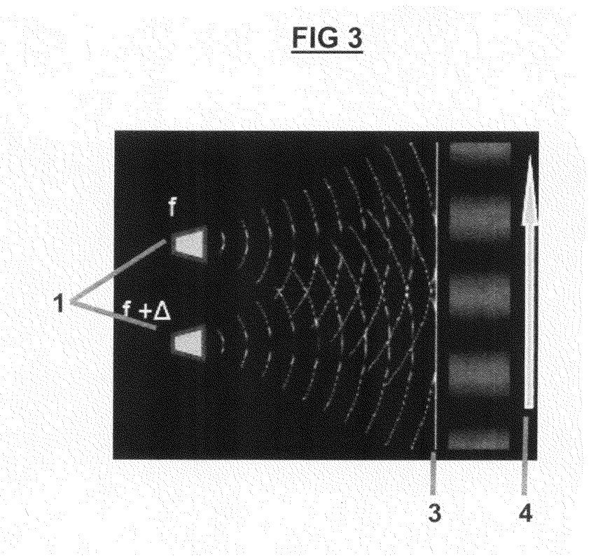

For each pair of Transmitting Sources 1, an interference pattern is created on the Target Object Plane 3, as shown in FIG. 3. Different pairs of transmitting sources create interference patterns of varying width and orientation. By slightly offsetting the frequencies transmitted by the sources the interference pattern can be caused to translate (move) across the target object plane 3 in the direction of arrow 4, sampling all areas of the target equally.

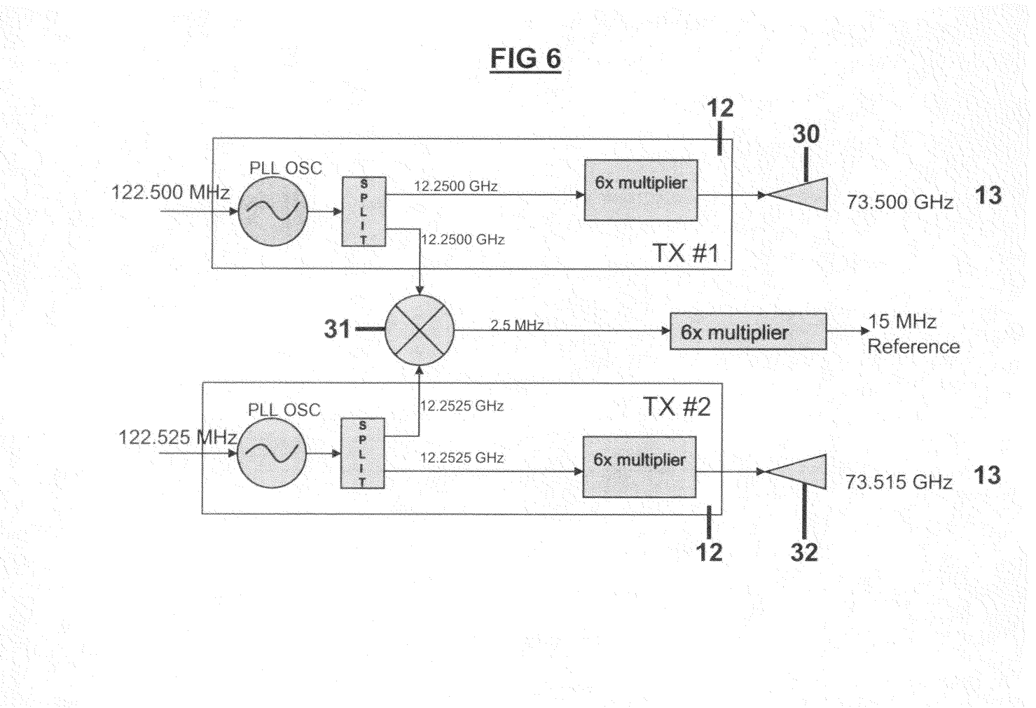

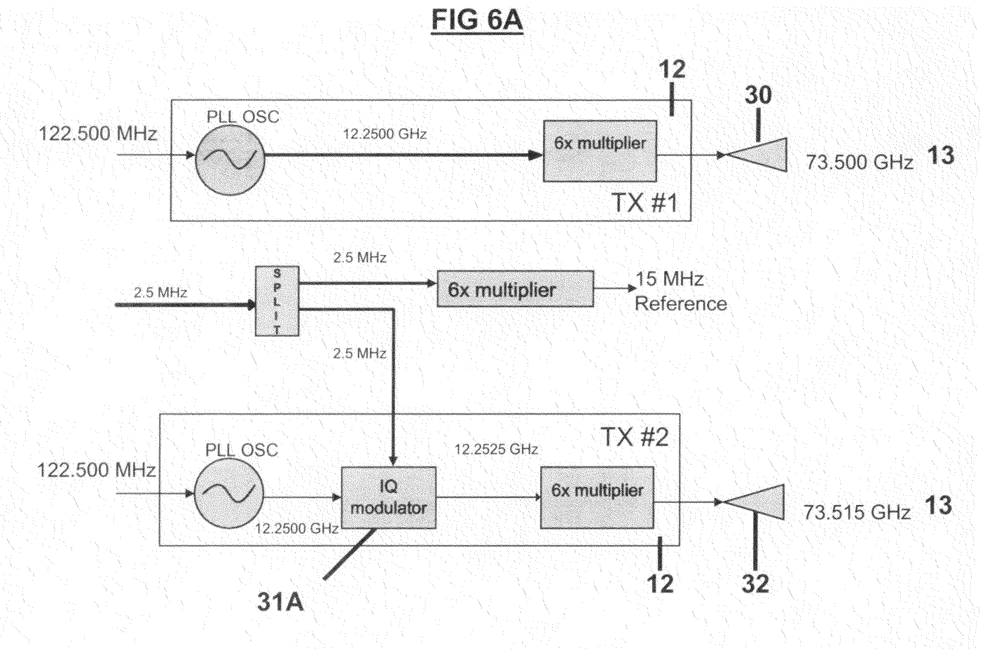

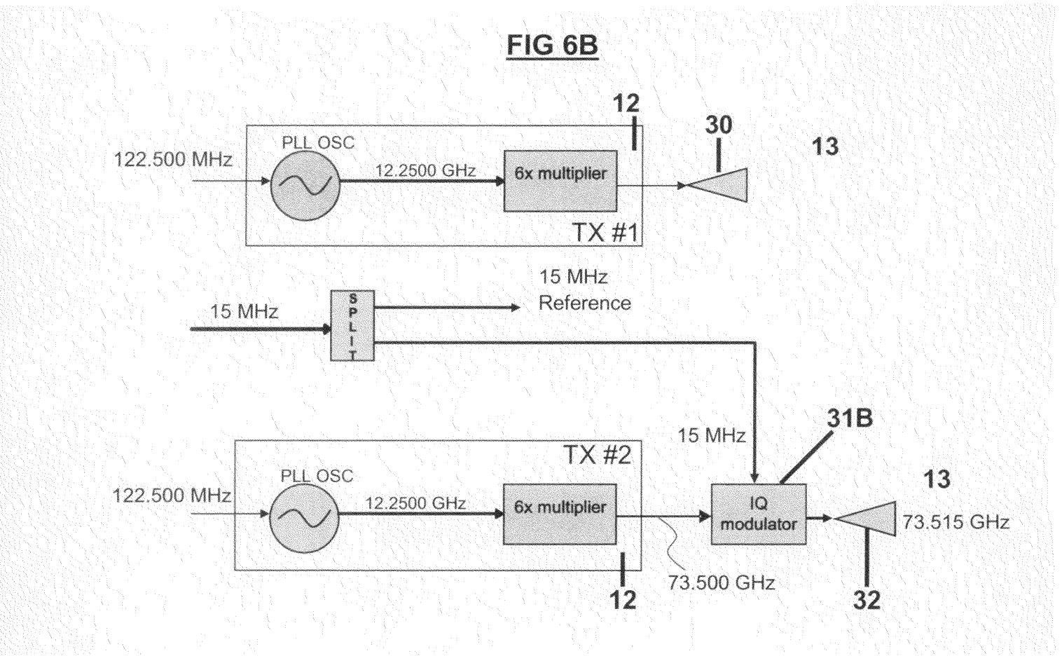

The block diagram for any pair of mmw transmitters in a preferred embodiment is shown in FIG. 6. These devices have been custom fabricated using techniques standard to the industry. In a preferred embodiment of the system sixteen of these devices will be arranged in a ‘Y’ shape with each leg of the ‘Y’ 1.5 meter in length. Transmitting antennas 30, and receiving antenna 32, typically made by Quinstar Corporation, are rectangular horn antennas, approximately 1″ wide, with approximately 12 degree beamwidth. The antenna beam patterns from all of the antennas must overlap to allow illumination of the target by more than one transmitter at a time, and to observe the reflected signal with the receiver.

A preferred embodiment of the system is composed of sixteen millimeter-wave (mmw) transmitters and a single receiver (as shown in FIG. 4), distributed over flat 3 meter×3 meter surface. Operating frequencies for the pairs of transmitting sources of 73.500 and 73.515 GHz have been selected, due to the good penetration of clothing at these frequencies and the availability of components. The millimeter-wave hardware is connected to a computer which performs the image reconstruction, system control, and user interface functions. The system is designed to provide approximately 3 cm resolution on targets at a range of 25 meters, and to operate at video frame rates.

Resolution of the system is determined by r=λR/D, where λ is the imaging wavelength, R is the range to the object, and D is the effective size of the aperture. For the proposed system,

$$\begin{matrix}Resolution r = λ R / D meters \\ = 0.003 m ( 25 m / 2.5 m ) \\ = 3 cm\end{matrix}$$

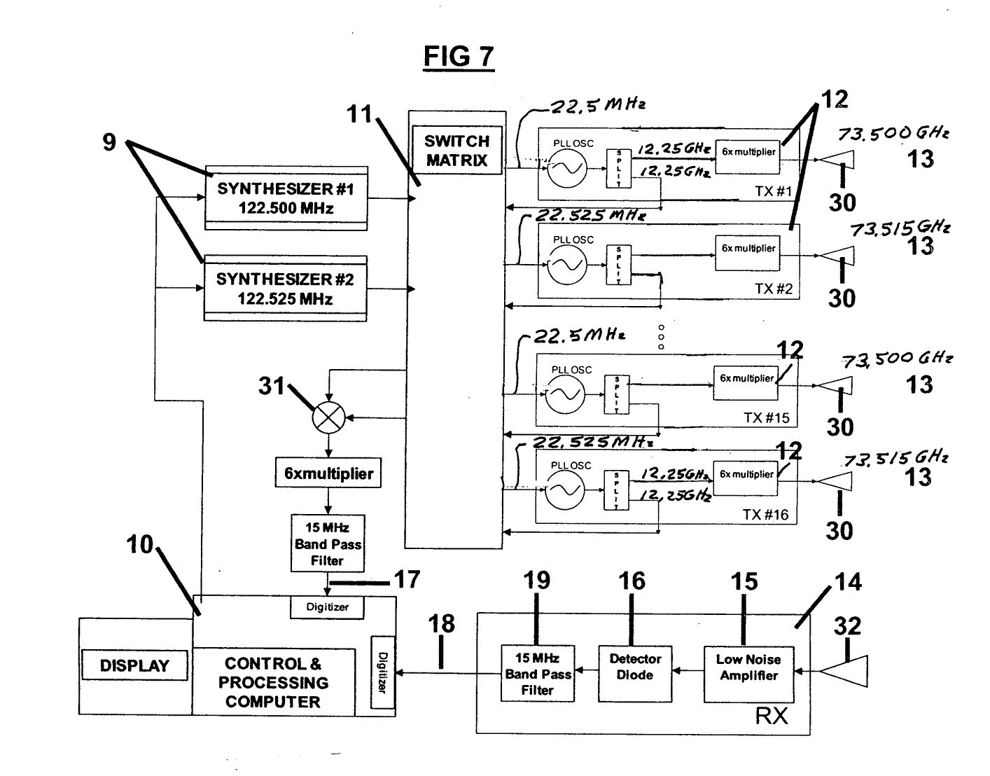

FIG. 7 shows an overall block diagram of the system. Frequency Synthesizers 9 and Switch Array 11 are controlled by Computer 10 to provide the output signals of Synthesizers 9 to pairs of Transmitters 12. For each Transmitter pair 12, the signals from the transmitters 13 are reflected off of the target and received by Receiver 14. The received signals are amplified by Low Noise Amplifier 15 and the receive power is detected by Detector Diode 16. The (received) signal from Detector Diode 16 is band pass filtered 19 and passed to Computer 10, where it is digitized and compared to Reference Signal 17. Each transmitter pair generates a Reference Signal 17 at 15 MHz by mixing the transmitters’ intermediate frequency (IF) outputs together in mixer 31. By comparison with Reference Signal 17, Received Signal 18 can be measured in phase and amplitude for the spatial frequency component corresponding to each transmitter pair. After each pair of transmitters has been activated, and the corresponding received signal measured and stored, Computer 10 performs an Inverse Fourier transform on the received signal data and presents the image on its display.

### System Applications

The concept of operations for the preferred embodiment is based on the integration of the imaging system into either a fixed-site or a mobile platform such as a flat-panel truck. Because Fourier Telescopy (FT) requires a finite baseline (separation of transmitters) to achieve resolution, it is anticipated that this system will require an approximate 15′×15′ surface. Several operational concepts are outlined below.

3-D Imaging

The FT imaging system of this invention has been described in terms of operating in a continuous wave (CW) manner, in which the signals are not used in any way to determine range. It is possible, however, to operate the system range-gated mode, where the transmitted signals are pulsed, and then the received signals are timed such that certain times corresponds to the reflection from surfaces at different ranges, similar to traditional radar. A pulsed system could be used to build up a 3-dimensional image of the field of view of the system. Similarly, a frequency-modulated or chirped system could also be used to establish the range of a particular image plane.

Crowd/Event Security

A system integrated into a 15′ flat-panel truck could be deployed rapidly to regions with high-tension levels, such as protests, demonstrations, or other gatherings. A fully integrated system could covertly scan a crowd at a reasonable stand-off distance, up to 50 m, and provide actionable information to individuals that may be carrying concealed weapons or explosives. Depending on the environment, several vehicles could be used simultaneously to provide different aspect angles on the crowd, increasing the likelihood of detection of high-risk individuals.

Random Check Points

The same flat-panel system outlined in 1.1 could be utilized in an ad-hoc manner, to provide random inspection points. In an Operation Enduring Freedom (OEF) environment, this system could complement random roadside checkpoints by scanning individuals at a distance after they are asked to leave their vehicles. Scanning drivers of suspect vehicles could provide an added safety margin for soldiers manning checkpoints since they would have knowledge of what the driver/passengers are or are not carrying (wires, radios, explosives, weapons). This could allow for a silent management of a hazardous situation, possibly helping soldiers/police manning the checkpoint to covertly control the individuals and vehicle.

Entry Portals and Choke Points

The same basic system could be integrated into fixed entry or ‘choke’ points, providing a real-time high resolution scan of individuals passing by. Such a system could be concealed and operated from a reasonable standoff distance. One concept would be to install an integrated FT scanner outside of embassy entry points, providing a stealthy means of inspecting individuals prior to their entry to embassy grounds. Individuals determined to be carrying explosives or weapons could be re-routed to a safe interdiction area without their knowledge, preventing premature action on their part.

Airborne Systems

MMW FT imaging systems may be mounted on aircraft or balloons and used to provide imaging through smoke, clouds, or darkness.

Over-the Horizon Imaging

FT systems using lower frequency radio emissions, such as those below 30 MHz, could be used to provide imaging of distant, over-the-horizon scenes by taking advantage of ionospheric bounce of these signals. Such FT systems would employ transmitters spaced 100's or 1000's of meters apart, in order to achieve good resolution of distance objects using these longe wavelength frequencies (30 MHz corresponds to approximately 10 m wavelength, for example)

### Variations

The reader will understand that many variations could be made to the specific embodiment described above without deviating from the main concepts of the invention. For example, there many potential transmitter layouts possible other than the Y-shaped layout of the first preferred embodiment. Also, each transmitter could have its own frequency which would result in a range of beat frequencies that could be monitored to produce the image.

Other preferred embodiments of the system are shown in FIG. 6A and FIG. 6B. These embodiments use similar clock oscillators at 122.500 MHz in both transmit and receive channels. In the second preferred embodiment, shown in FIG. 6A, an I-Q modulator 31A is used to shift frequency in one of the transmitters illuminating the target by 2.5 MHz which is then passes through an ×6 frequency multiplication circuit. As a result, the frequency of the mm-wave transmit signal is shifted by the same amount of 15 MHz as in the first preferred embodiment. The use of I-Q modulation in the 12.5 GHz range reduces system noise resulting from ×100 clock frequency multiplication in the PLL oscillator circuit. The reference signal is derived from the same 2.5 MHz source by multiplying its frequency by an ×6 factor. The third preferred embodiment is shown in FIG. 6B wherein an I-Q modulator introduces frequency shift of 15 MHz to a 73.5 GHz synthesized oscillator. After modulation the transmitter output frequency is 73.515 GHz which is the same as in the other embodiments. The 15 MHz modulating signal is also used directly as the reference signal for processing receive signals of the imaging system.

Therefore, the scope of the present invention should be determined by the appended claims and their legal equivalents.

What is claimed is:

1. A sparse array millimeter-wave imaging system comprising:
A) a plurality of millimeter wave radio transmitters arrayed in a pattern and adapted to transmit millimeter wave radiation with at least two transmitters transmitting simultaneously at slightly different millimeter wave frequencies so as to produce interferences fringes that sweep across the target,
B) at least one detector adapted to detect millimeter-wave radiation at the at least two frequencies reflected from the target to provide at least one set of beat frequency data,
C) a computer processor programmed to process the beat frequency data to produce an image of the target.

2. A system as in claim 1 wherein said transmitters are pulsed permitting range information to be extracted from the beat frequency data.

3. A system as in claim 1 wherein said transmitters are pulsed permitting image information to be obtained from a plurality of target planes.
